(19) United States
(12) Patent Application Publication
(10) Pub. No.: US 2026/0349699 A1
(43) Pub. Date: Nov. 5, 2026

(54) METHOD, FIELD DEVICE SYSTEM AND INSTRUCTION SET FOR REDUCING DOWNTIMES IN THE UPDATING OF INDIVIDUALLY EXECUTABLE SOFTWARE PACKAGES

(71) Applicant: Samson Aktiengesellschaft, Frankfurt am Main (DE)

(72) Inventors: Christian Merkator, Hofheim Am Taunus (DE); Jens Sticksel, Seligenstadt (DE); Christoph Stein, Rodenbach (DE); David Wagner-Stürz, Mühltal (DE)

(73) Assignee: Samson Aktiengesellschaft, Frankfurt am Main (DE)

(21) Appl. No.: 19/164,341

(22) PCT Filed: Mar. 6, 2024
(86) PCT No.: PCT/EP2024/055893

§ 371 Date: Jul. 13, 2026

(30) Foreign Application Priority Data
Mar. 14, 2023 (DE) 10 2023 106 319.7

(51) Int. Cl. G06F 8/65

(52) U.S. Cl. CPC G06F 8/65

(57) ABSTRACT

The disclosure relates to a method for reducing downtimes in the updating of individually executable software packages for controlling and/or monitoring a field device, in particular control valve and/or an attachment for a control valve, of a process engineering system. The method may include a) announcement of an upcoming update of at least one of the software packages; b) categorization of the update as a function of defined conditions; and c) definition of the time of the update and/or of bridging functions to be carried out during the update as a function of the categorization.

### CROSS REFERENCE TO RELATED APPLICATIONS

This patent application is a U.S. national stage application of International Application No. PCT/EP2024/055893, filed Mar. 6, 2024, which claims priority to German Patent Application No. 10 2023 106 319.7, filed Mar. 14, 2023, each of which is incorporated herein by reference in its entirety.

### BACKGROUND

The disclosure relates to a method for reducing downtimes in the updating of individually executable software packages for controlling and/or monitoring a field device of a process engineering plant, such as a chemical plant, for example a refinery, a power plant, for example a nuclear power plant, a food processing plant or the like, a field device system and an instruction set. The field device is designed in particular as a control valve.

In process engineering plants, various technologies are used for data transmission. Many control valves use a combined two-wire connection for combined signal and power transmission. On the two-wire connection, a 4 . . . 20 mA signal is transmitted to the control valve by a central computing unit, for example, a central control room of a process engineering system. For example, a 4 mA control signal can cause the control valve to move into a closed position, whereas a 20 mA signal can cause the control valve to move into a maximum open position. Signals in the range between 4 and 20 mA can cause the control valve to assume a predetermined intermediate position between the closed position and the maximum open position, which can be proportional to the current signal, for example. A passive field device in the form of a sensor can transmit an analog 4 . . . 20 mA signal to a central computing unit in order to report information about a process fluid in the process engineering system, for example, a part or a component of the process engineering system. For example, a current signal proportional to a specific pressure range can be transmitted from a pressure sensor to a central computing unit. The transmission of information or data by means of a 4 . . . 20 mA signal is limited to very small data quantities.

Also common for the transmission of data in process engineering plants are the HART protocol, the FOUNDATION Fieldbus protocol, the PROFIBUS protocol, and a number of other digital communication technologies. Since 2007, HART has been part of the field bus standard IEC 61158. For data transmission according to the HART protocol, an analog signal, for example a 4 . . . 20 mA signal, is superimposed with a high-frequency oscillation, for example ±0.5 mA. In this case, a digital 1 with the frequency 1.2 kHz and a digital “0” with the frequency 2.2 kHz can be represented. HART permits the transmission of process and diagnostic information and control signals between control valves and a superordinate computing unit, for example a central control room.

In some process engineering systems, data are transmitted from a central computing unit to control valves using what is known as “power over Ethernet” technology. Power over Ethernet (PoE) denotes a technology with which network-capable devices are supplied with power via an 8-wire Ethernet cable. Data transmission by means of PoE takes place in accordance with the IEEE standard 802.3af (July 2003). Power over Ethernet systems are intended to save power supply cables in order to supply network-capable devices with power at locations that are difficult to access or are restricted. According to the IEEE standard 802.3af, participating devices can be divided into energy suppliers (power sourcing equipment, PSE) and consumers (power devices, PD). In operation, 48 V is provided as supply voltage for the consumers. The maximum power consumption of the devices is 350 mA, wherein up to 400 mA are permitted, resulting in a maximum power consumption per device of 14.5 W. Free wires and/or signal-carrying wires of the Ethernet cable can be used for the transmission of the power. PoE allows the rapid transmission of large data quantities. The power density of PoE technology does not allow its use in explosion-prone areas. The use of PoE technology requires a much higher investment effort than analog 4 . . . 20 mA communication. Enormous investments, which are uneconomic in many cases, are also required for retrofitting existing process engineering plants with PoE technology. A control valve which is supplied with power via an Ethernet connection (power over Ethernet) and an associated start-up method is described in DE 10 2006 036 770 A1.

An approach for linking data transmission on the one hand by Ethernet and on the other hand by means of established and widely used communication technologies of process engineering plants implements what is known as Advanced Physical Layer (APL) technology, in particular in accordance with the standard IEEE P802.3cg (2016). In contrast to PoE technology, APL technology is intended to be suitable in particular for including network-capable devices in explosion-prone areas (Zone 0 and 1/Division 1). Zone 0 describes an area in which an explosive gas-air mixture is present permanently or for long periods of time. Zone 1 describes an area in which combustible or conductive dust particles are present, and areas in which an explosive gas-air mixture may be present for a short time under normal operating conditions. By means of APL technology, it is also intended to be possible to design field devices in an intrinsically safe manner. By means of twisted-care wires (twisted-care wiring according to 10BASE-T1L), data transmission rates of 10 Mb/s up to 100 Mb/s and more are to be achieved. Process engineering systems using APL technology can be equipped with a so-called trunk data and power transmission line, in particular with a length of up to 1000 m, from a central computing unit to an APL field switch (APL switch). The so-called trunk lines (trunk line) should be designed for transmitting powers of up to 54 W. A plurality of field devices having so-called track data and power transmission lines, in particular with a length of up to 200 m (stub line), can be connected to what is known as an APL field switch. The track lines are configured to provide a power of usually at most 500 mW. An IEC 61158 type A field bus cable, which has twisted-care wires and an electrically shielding sheath (also referred to as a shield), is usually used as a data and power transmission line. Such lines are referred to below in simplified form as Ethernet APL connections. According to the APL standard IEEE P802.3cg (2016), electrically shielding cables have to be used for the connection between an APL field switch and each individual field device. Up to five field devices can be connected to a track line. A plurality of APL field switches, for example, at most 5 up to at most 10 APL field switches, can be connected to a trunk line. APL technology is compatible with the operation of field devices in explosion-prone areas. For this purpose, a low power density may be provided in order to prevent the electrical and/or thermal energy present on a field device from being able to reach above an ignition threshold even under abnormal operating conditions. The APL field switches and field devices are designed to be ignition-proof (explosion-proof) according to the protection class “Ex i”.

The APL technology permits the transmission of large data volumes and is distinguished by compatibility with existing two-wire communication systems. However, many users, even in the case of APL technology, complain about the very high investment costs for upgrading or retrofitting a complete plant. In order to reduce the costs and the installation space of the APL technology, WO 2022/043103 A1 proposes positioning an APL field switch together with a position controller connected thereto in a common housing with explosion protection, which is formed separately and at a distance from a control valve, the actuator of which is actuated via the position controller.

However, the solution from WO 2022/043103 A1 does not exploit the full potential of APL technology. This is because APL technology makes it possible to lay lines with a high data transmission speed and with a power supply over distances of up to 200 meters into explosion-prone areas of Zone 1 or 0 via the two-wire stub lines, which makes it possible to equip the control valves themselves with computing units, such as those of the position controller and/or of a sensor. As a result, the control valves can be formed as network-capable devices, which increases the functionality and flexibility of the control valves and simplifies the cabling complexity of control valves having many functionalities.

It is to be expected that, as a result of the use of network-capable control valves, in particular in conjunction with APL technology, new functionalities and safety measures, in particular against unauthorized accesses to the control valves via the network, will arise at ever shorter intervals, which will entail an increase in the frequency of updates on the one hand and in the risk of downtime on the other hand on account of the higher complexity. Both the failure and the updating of field devices are currently associated with downtimes of the control valve, and in the worst case of the process engineering plant, which results in high costs.

### BRIEF DESCRIPTION OF THE DRAWINGS/FIGURES

The accompanying drawings illustrate the embodiments of the present disclosure and, together with the description, further serve to explain the principles of the embodiments and to enable a person skilled in the pertinent art to make and use the embodiments.

FIG. 1 shows a schematic flowchart of a method according to the disclosure.

FIG. 2 shows a field device system according to the disclosure.

FIG. 3 shows a schematic illustration of a process engineering plant according to the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the disclosure is to overcome the disadvantages of the previous techniques, including to provide a method, a control valve system and an instruction set, with which downtimes of field devices, in particular control valves, and/or process engineering plants with field devices, in particular control valves, can be reduced.

One aspect of the disclosure relates to a method for reducing downtimes in the updating of individually executable software packages for controlling and/or monitoring a field device, in particular a control valve and/or an attachment for a control valve, of a process engineering plant. The method may comprise the following steps:
a) announcement of an upcoming update of at least one of the software packages;
b) categorization of the update as a function of defined conditions;
c) definition of the time of the update and/or of bridging functions to be carried out during the update as a function of the categorization.

Preferably, the software packages comprise software packages for controlling position controllers, in particular, position controllers of control valves. In particular, in the case of position controllers for control valves, updates are often required in order to update control parameters, communication protocols and/or parameters, limit values of various parameters or the firmware of the control device. The use of Ethernet APL or the connection of field devices in process plants to Ethernet APL and/or the modernization of process plants with modern technologies and optionally further sensor technology will lead to a further increase in the frequency of updates of the field devices.

In the prior art, the field devices are briefly deactivated before updates, or are put into an operating mode in which the field device and/or the process engineering plant has to be paused. Downtimes caused thereby can significantly reduce the economic viability of process engineering plants.

The software packages can be stored and/or executed on at least one computing unit. The computing unit can be designed to carry out one or more of the functions described above and below. In particular, the computing unit can be or comprise a controller for the communication between field devices, in particular, with a further field device, such as a control valve, an attachment, a switch, a diagnostic box and/or a superordinate system. However, the computing unit can also be responsible for other functions, for example of the field device or of further field devices. The at least one computing unit can be arranged on the field device, in particular control valve, or can be arranged at a distance from the field device. The arrangement on the field device can take place via integration of the computing unit into the field device, in particular into the position controller of a field device designed as a control valve, or via an attachment to be attached to the field device. The spaced-apart arrangement can take place via integration of the at least one computing unit into another field device, in particular control valve, diagnostic box, a switch, in particular APL switch, and/or a superordinate system, in particular a safety controller, a control line system or a diagnostic system. However, it is also conceivable for the software packages to be distributed over different devices, in particular selected from one or more field device(s), attachment(s), diagnostic box(s) and/or superordinate system(s), of the process engineering system. For example, the process engineering system can have a plurality of field devices, in particular control valves, attachments, in particular sensors, at least one diagnostic box and/or at least one superordinate system, which are preferably connected to one another via Ethernet, in particular Ethernet APL.

The at least one field device, in particular control valve and/or attachment for a control valve, is preferably designed for use in explosion-prone areas, in particular Zone 0, 1 or 2. The field device is preferably connected via Ethernet, in particular, Ethernet APL, to a superordinate unit, in particular a diagnostic box and/or a switch, which is arranged in particular in a less explosion-prone area than the field devices. For example, the field devices can be arranged in zone 0 and the superordinate unit in zone 1 or zone 2. Alternatively, the field devices can be arranged in zone 1 and the superordinate unit in zone 2.

It can be provided that the field device has firmware, which in turn has a plurality of software packages. Preferably, the software packages to be updated, in particular firmware, can be updated separately. In particular, the software packages to be updated can be software packages for controlling and/or monitoring different functions of the field device, in particular, control valve, attachment for a control valve, control device for a measuring device, pump, actuator and/or sensor, such as a camera and/or a sensor. Alternatively, or additionally, the software packages to be updated can be software packages for controlling and/or monitoring a plurality of, in particular identical or different, field devices, in particular control valves, attachments for a control valve, control devices for a measuring device, pumps, actuators and/or sensors. In particular, the software packages to be updated can be different software packages or a plurality of identical software packages.

It can be provided that the field device has a plurality of functions, which can each be executed via individual software packages. For example, the field device can each comprise individual software packages for executing functions relating to a communication via a bus, a user interface, a fault diagnosis, a pneumatic system, in particular an air power amplifier, and/or a closed-loop control and/or position capture of a valve position of a field device configured as a control valve. It is conceivable that the field device comprises a plurality of computing units, such as microcontrollers or the like, which are each provided for executing one or more of these software packages. Preferably, precisely one computing unit is provided in each case for executing an individual software package. However, it is also conceivable that a computing unit assumes a function of another computing unit, for example during updating. For example, it is conceivable that the computing unit to be updated or its software package can be replaced for a short time, for example by a second computing unit within the field device of the process engineering system. The second computing unit can be used for executing a bridging function. For example, the second computing unit can at least partially or completely assume the function of a software package on the first computing unit, while the software package is updated on the first computing unit. After the updating, the first computing unit can then again assume the respective function.

Individually executable software packages can be understood to mean, in particular, individually executable program blocks. Preferably, the individually executable software packages can additionally be individually updated. The individually executable software packages can be part of software which has further software packages. Preferably, the software packages can be individually updated in such a way that, in the case of an update of a software package, the function of the other software packages of the software is at least partially, preferably completely, maintained. In particular, the individually executable software packages are function-oriented software packages. This is to be understood to mean, in particular, that a software package is responsible in each case for at least, in particular precisely, one function of the field device.

The updating of software packages can be understood to mean, in particular, the adaptation of control parameters, communication parameters and/or protocols, for example bus operating settings, Ethernet or APL communication protocols or the like, and/or the updating of software packages, in particular, firmware packages. In embodiments in which field devices use Ethernet APL connections, in particular in order to connect them to other field devices, diagnostic boxes, switches and/or superordinate systems, limit values, communication parameters and/or communication protocols are preferably changed and/or updated by means of the update.

It can be provided that the updates are announced by means of computing units. In particular, the updates of one or more devices, in particular selected from one or more field device(s), attachment(s), diagnostic box(s), switches and/or superordinate system(s), such as a safety controller and/or a process control system, of the process engineering system can be announced. In particular, the updates can be announced by at least one computing unit of the device. Preferably, the update is announced by a device selected from a diagnostic box, a switch and/or a superordinate system, in particular a computing unit installed therein.

The announcement of an upcoming update of at least one software package in step a) can be triggered by one or more of the causes selected from the presence of a new version of the software package, a failure or a disruption of a function, a malfunction of a field device, a safety gap and/or an adaptation of at least one control parameter. In particular, step a) can be triggered in that possible causes, in particular of one or more of the above-described device(s)/computing unit(s), are queried and, when they are present, an update is announced. For example, a diagnostic box can query, in particular, at regular time intervals, the presence of one of the above-described causes and, when they are present, announce an update. Alternatively, or additionally, an update can be carried out in that the presence of a cause, for example a disruption of a function, is communicated to a device, in particular, a superordinate system, and the device then announces an update. For example, a device monitoring the process fluid flow, in particular, a diagnostic box, can announce an update of the control parameters of a software package, in particular, of a control valve influencing the process fluid flow, when a flow which is too large or small in relation to a set valve position is established. Alternatively, or additionally, for example when a new version of a software package is present, a superordinate system can announce the update of this software package, in particular, announce it to a diagnostic box.

It is conceivable that, in step a), the announcement of a plurality of updates takes place, in particular, simultaneously or offset in terms of time. It can be provided, in particular, that, in the method in step a), before the categorization of an announced update in step b), a wait is made for a predetermined time period, in particular of 1 to 300 seconds, preferably 5 to 180 seconds, particularly preferably 10 to 60 seconds, as to whether one or more further updates are announced, so that the categorization in step b) can take place taking into consideration a plurality of announced updates.

The defined conditions as a function of which the updates are categorized in step comprise, in particular, a query of the function of the software package to be updated, in particular its relevance for operation of the field device, the type of update, in particular its importance for the respective function, the presence of a fault, a state of the field device within operation in the process system, for example the position of a field device formed as a control valve, the cause of the update, an urgency of a parameter of a field device to be changed and/or the possible reaction to a brief failure of the computing unit assigned to the respective software package. Updates in step b) are preferably categorized based on at least two, preferably three, categories which are selected, in particular, from, function-critical or non-function-critical, failure-critical or non-failure-critical and/or time-critical or non-time-critical. In this case, the categorization is preferably carried out in each case on the basis of the predetermined conditions described below.

As a function of the categorization, in particular prioritization, carried out in step b), updates, in particular in step c), are preferably prioritized differently or treated differently during the update.

If a plurality of updates are announced in step a), the categorizations of the other updates are preferably considered in the definition of the time of an update and/or of bridging functions to be carried out during the update in step c). If, for example, an update is categorized as time-critical and an update as non-time-critical, the update categorized as time-critical can be prioritized in terms of time with respect to the update categorized as non-time-critical. Alternatively, or additionally, in the case of an update categorized as function-critical and an update categorized as non-function-critical, the update categorized as function-critical can be prioritized in terms of time with respect to the update categorized as non-function-critical. Alternatively, or additionally, in the case of two updates categorized as failure-critical, a common time for carrying out both updates can be defined at which the process engineering plant is switched off, for example, or field devices designed as control valves are brought into a safety position.

Furthermore, it can be provided that, in the case of one or more updates categorized as non-failure-critical, a bridging function is initiated before the respective updating is carried out. A bridging function is to be understood to mean, in particular, a function which at least partially assumes the function of the software package to be updated. The bridging function can be executed by the same device, in particular field device, on which the updating is carried out or can be carried out by another device, in particular attachment or diagnostic box.

Downtimes in the updating of field devices of a process engineering plant can be reduced by the method according to the disclosure. In particular, downtimes can be avoided unnecessarily by the definition of the time of the update on the basis of the previously carried out categorization, for example by defining a time for the update at which the update can take place without downtimes of the process engineering plant. For example, updates categorized as non-function-critical can take place without switching off the process engineering plant, so that no downtimes arise for such updates. Furthermore, downtimes can be avoided for updates categorized as non-failure-critical by bridging functions being initiated which assume the function of the software package during the updating. Furthermore, in the case of updates categorized as time-critical, longer downtimes can be avoided by carrying out an updating which is as timely as possible. Furthermore, downtimes can be reduced by taking account of the categorization of a plurality of updates, for example by carrying out a plurality of failure-critical updates simultaneously.

In particular in combination with a connection of a plurality of devices, in particular control valves, attachments, switches, diagnostic boxes and/or superordinate systems, to one another via Ethernet APL, owing to the increased data transmission rate of Ethernet APL, a rapid categorization of a plurality of updates can take place and an efficient comparison of the categorization of different updates can take place. Furthermore, Ethernet APL enables the implementation of bridging functions to a particular extent. In particular, owing to the Ethernet APL technology, a wide variety of devices, in particular attachments, control valves, diagnostic boxes, switches and/or superordinate systems, can be used for carrying out bridging functions. For example, an attachment of a control valve or a diagnostic box connected to the control valve can have software packages, in particular on corresponding computing units, which can execute bridging functions for the control valve, for example for the position controller, during the updating of the software packages thereof. Alternatively, or additionally, in the case of process engineering plants having a plurality of control valves, in each case one control valve can provide a bypass function for another control valve. In this case, the control valves can be connected to one another either directly or via a switch or a diagnostic box, in particular by means of Ethernet APL.

It can be provided that, in step b), updates of software packages whose function is defined as a primary function of the field device, in particular control valve and/or attachment, and/or of the process engineering plant are categorized as function-critical updates, wherein, in particular, updates which do not meet this condition are categorized as non-function-critical updates. It can be provided that such functions are defined as a primary function which are defined as being important for the operation and/or the safety of the field device and/or of the process engineering plant.

It can be provided that functions for controlling the control valve position of a field device configured as a control valve, for providing safety functions, in particular the reaction to a spontaneous pressure loss in the field device, for communicating the field device with a safety controller and/or a process control system and/or for the pneumatic system of pneumatically driven field devices, in particular control valves, are defined as a primary function. Alternatively, or additionally, it can be provided that functions relating to a user interface and/or diagnostic functions are not defined as a primary function, in particular, as a secondary function. It can be provided that, in the case of functions defined as a primary function, in particular in the case of functions for reacting to a spontaneous pressure loss in the field device, such as functions for putting a control valve configured as a field device into a safety position, in particular via a safety controller, an update is carried out only if a bridging function is available for the period of the update or the field device or the process engineering plant is in a maintenance state, in particular switched off. Alternatively, or additionally, it can be provided that, in the case of functions, which are not categorized as a primary function, the functions are deactivated for the period of the update, in particular, without a bridging function. In particular, functions, which are not categorized as a primary function can be deactivated and/or updated individually, successively or together. In particular, it can be provided that, in the case of computing capacities which are available to a limited extent, updates of functions categorized as a primary function are updated in a prioritized manner with respect to functions, which are not categorized as a primary function. For example, if, in step a), the updating of two software packages is announced, one of which executes a function categorized as a primary function and one of which executes a function categorized as a secondary function, and the updating of both software packages would lead to an excessively high utilization of the computing capacity, only the updating of the software package with the function defined as a primary function can be executed.

The inventors have recognized that, in particular, the functions previously defined as primary function are of high importance for reliable and safe operation of field devices, such that a corresponding prioritization of these functions in step c) leads to a reduction in downtimes.

It can be provided that, in step c), for updates categorized as non-function-critical, a time for the updating is defined at which computing capacities required for the updating are not required for updates categorized as function-critical.

It can be provided that, in step b), updates of software packages whose function is defined as being able to be compensated during the update are categorized as non-failure-critical updates, wherein, in particular, updates, which do not meet this condition, are categorized as failure-critical updates. Alternatively or additionally, it can be provided that, in step b), updates of software packages whose function is defined as being able to be compensated in the event of an unplanned failure of a device or of a control unit on which the software package is installed are categorized as non-failure-critical updates, wherein, in particular, updates which do not meet this condition are categorized as failure-critical updates.

It can be provided that functions for which a bridging function is available, in particular functions which can be at least partially, in particular in the form of a rudimentary basic function or a control routine, or completely, in particular by a second software package with the same function, during an update, are defined as being able to be compensated, wherein preferably functions defined as primary functions of the field device can be at least partially or completely adopted, preferably are adopted, during an update.

It can be provided that, in step c), for updates categorized as non-failure-critical, bridging functions for compensating the function affected by the updating are initiated before the updating is carried out.

It can be provided that the bridging functions are selected from one or more of the following bridging functions:
1. Complete adoption of the concerned function during the update, in particular by a second software package, which is preferably stored on a second computing unit, in particular within the field device, of another field device of the process engineering system or a diagnostic box;
2. Partial compensation by an, in particular autonomous, control routine during the update, which is provided in particular by a second software package, which is preferably stored on a second computing unit, in particular within the field device, of another field device of the process engineering system or a diagnostic box;
3. Partial compensation by a rudimentary basic function during the update, in particular wherein, in the updating of a software package for controlling the control valve position of a field device configured as a control valve, a setpoint value for holding the control valve position is held, in particular, is held by a process control system.

It is conceivable that, as a function of the categorization in step b), a bridging function is selected, in particular in order to avoid a total failure of the field device and/or of the process engineering system. For example, it is conceivable that, in an upcoming update of a software package for a communication of a control valve or position controller to the outside, in particular with the process control system, a rudimentary basic function is provided, in particular a setpoint value for closed-loop control of the valve position is held. Thus, no closed-loop control of the valve position can take place in the period of the update, but the control valve can continue to be operated without moving into a safety position. It is also conceivable that, in particular in applications in which a field device, in particular control valve, carries out a certain closed-loop control more often, a control routine is stored, for example in another software package or another computing unit or an analog control logic. During the updating, this control routine can then be executed automatically/autonomously until the communication is enabled again. This is conceivably essentially analogously also in the case of an update of a package for closed-loop control of a valve position.

It can be provided that the function is adopted again by the updated software package after the updating. In particular, the bridging function can be ended as soon as the function is adopted again by the updated software package.

It can be provided that, in step c), for updates categorized as non-failure-critical, a time for the updating is defined at which computing capacity required for the updating is not required for updates categorized as failure-critical.

It can be provided that, in step c), for updates categorized as non-function-critical and as failure-critical, a time for the updating is defined at which computing capacities required for the updating are not required for updates categorized as function-critical and as non-failure-critical. Preferably, a time for the updating can be defined at which a field device designed as a control valve is in a safety position. Preferably, it can be checked for this purpose whether an expected time, in which the control valve is in a safety position, is sufficient for the updating. In particular, a comparison between the time expected to be required for the updating and the time, in which the control valve is in a safety position, in particular as planned, can be carried out. Preferably, the updating is carried out only when the expected time for the updating is less than the time, in which the control valve is in a safety position.

It can be provided that, in step c), for updates categorized as function-critical and as non-failure-critical, a time for the updating is defined at which sufficient computing capacity is available for the updating and for the bridging function.

It can be provided that, in step c), for updates categorized as failure-critical, the time of the updating is defined as a function of an instantaneously or future planned operation of the field device and/or of the process engineering plant, wherein in particular a non-process-critical time is defined. Preferably, a time at which no change in position of a control valve, no change in a fluid, no change in the flow through the field device, in particular control valve, and/or generally no flow of fluid through the field device, in particular control valve, is provided is defined as a non-process-critical time. For this purpose, a query, in particular to a superordinate system, preferably process control system, can be made after a non-process-critical time.

The definition of the time for the updating as a function of an instantaneously or future planned operation of the field device and/or of the process engineering plant can take place in particular if no bridging function is available for this function.

It can be provided that the time of the updating is defined as a function of a control signal of the process control system, a state of the computing unit and/or a state of the safety controller.

It can be provided that the time of the updating is defined in a time window in which no changes in the control valve position of a field device configured as a control valve are planned, in particular wherein, in the case of updates of software packages which relate to the control of the control valve position, a bridging function, in particular one of the above-described bridging functions, is carried out in step c). As a result, updating of a software package can take place without having to accept a downtime of the control valve.

It can be provided that, in step b), updates which are announced as a consequence of a cause defined as urgent are categorized as time-critical updates, wherein, in particular, updates which do not meet this condition are categorized as non-time-critical updates.

It can be provided that the failure or the disruption of a function defined as a primary function, a malfunction of a field device and/or safety gaps, in particular with respect to access from outside to the field device, to other field devices of the process engineering plant or to the entire process engineering plant, are defined as an urgent cause, wherein, in particular, the adaptation of control parameters or the failure of functions not defined as a primary function are not defined as an urgent cause.

It can be provided that, in step c), for updates categorized as non-time-critical, a time for the updating is defined at which computing capacity required for the updating is not required for updates categorized as time-critical.

It can be provided that, for updates categorized as both function-critical and/or time-critical and as failure-critical, in step c), a decision is made by means of an algorithm on the basis of weighting factors as to whether a downtime of the field device and/or of the process engineering plant is accepted in favor of a timely update, or whether the update is shifted to a time at which the update can be carried out without, with little or during a planned downtime. It can be provided that such an algorithm is executed via a superordinate computing unit or within a computing unit of a field device, in particular of the field device on which the software package is to be updated, or on another field device.

A downtime within the meaning of the present disclosure can be understood to mean downtimes as a result of planned downtimes, for example on account of an updating or maintenance to be carried out, of the process engineering plant and/or unplanned downtimes, for example as a result of a failure of a device, in particular a control valve.

It can be provided that, in step c), the field device, in particular control valve, is brought into a safety position, in particular closed position, before an updating categorized as failure-critical and/or as function-critical is carried out. In particular, it is conceivable that, in the case of functions of software packages for which no bridging function is available, one or more valves affected by the updating is/are brought into a safety position or another predefined basic position, in particular safety position.

It can be provided that updates are blocked in step c) if they would lead to an excessively high utilization of computing capacities and/or if the computing capacities of the computing unit on which the software package to be updated is executed and/or stored already have an excessively high utilization of computing capacities. Under an excessively high utilization of computing capacities, in particular a utilization of more than 50%, 60%, 70%, 75%, 80%, 85% or 90%, preferably of more than 80%, of the computing capacity can be stored. The inventors have recognized that, in particular in the case of an excessively high utilization of the computing capacity, in particular of more than 80%, the risk of a slowdown and in the worst case of a total failure, in particular of functions defined as a primary function, significantly increases. Downtimes can be significantly reduced by blocking updates in such situations.

It can be provided that the software packages are distributed over a plurality of computing units and/or devices, in particular field devices, attachments, a diagnostic box and/or superordinate systems, of the process engineering system, which are preferably connected to one another via Ethernet, in particular Ethernet APL, and/or a switch, in particular APL switch. The method is preferably used in a process engineering system having at least one field device, in particular control valve, and/or at least one attachment, in particular sensor, which is connected, in particular by means of Ethernet APL, to at least one further field device, in particular control valve, and/or at least one further attachment, in particular sensor, in particular by means of Ethernet, preferably Ethernet APL. The connection can take place directly or indirectly, for example via a switch, in particular an APL switch.

In particular as a result of the connection of a plurality of computing units and/or a plurality of devices to one another via Ethernet APL, the software packages can be distributed over the different computing units and/or devices, wherein a high time resolution with extremely large data quantities is made available as a result of the high bandwidth of Ethernet APL. As a result, with the method, the categorization of the updates in step b) can take place particularly efficiently and taking into consideration as many conditions as possible, such as the function of the software packages, the compensatability of the software packages, the urgency of the update and/or the cause of the update. As a result, the definition of time and/or bridging functions to be carried out during the update in step c) can take place particularly efficiently to the effect that downtimes of the field device and/or of the process engineering plant are reduced.

It can be provided that, for the definition of the time of the update, step c), a coordination between devices of the process engineering plant takes place, in particular wherein the time of the updates of a software package of a first device takes place as a function of an upcoming maintenance or update on a second device. Alternatively, or additionally, the update of software packages of a plurality of devices, in particular for the communication of the devices with one another, can take place simultaneously for all devices, in particular of a node or system.

When a plurality of devices and/or a plurality of computing units are present, steps a) to c) can take place individually or jointly for each device and/or computing unit, in particular in order to determine a suitable time for an update. For example, in the case of a plurality of planned updates, the categorizations of the individual updates in step b) can be compared with one another in order to define suitable times and/or suitable bridging functions for the individual updates in step c).

It can be provided that, during the carrying out of a bridging function, in particular by means of a control routine, in step c), the bridging function is communicated to other devices, in particular devices in the respective part of the process plant, and/or these take the bridging function into account in their behavior, in particular with regard to their own updates. For example, in the case of a field device configured as a control valve, the bridging function can be a control routine replacing the control function of the control valve, wherein the control routine is communicated to other devices and/or these take the control routine into account in their behavior.

A further aspect of the disclosure relates to a field device system, in particular control valve system, for controlling a process fluid flow of a process engineering plant, such as a chemical plant, a power plant, a food processing plant or the like. The field device system comprises at least one, preferably at least two, three, four or five, individually executable software package(s) for controlling and/or monitoring a field device, in particular a control valve, and at least one computing unit which is designed, during the announcement of an upcoming update of a software package, to categorize the update as a function of defined conditions and, as a function of the categorization, to carry out a time of the update and/or bridging functions to be carried out during the update, in particular to carry them out according to the method described above.

In particular, the field device system comprises at least one, preferably at least two, three or four, particularly preferably at least five, eight or ten, field devices. A field device within the meaning of the present disclosure can be, for example, a control device, a measuring device or an actuator. A field device can be, for example, a control valve for controlling a branch of the process fluid flow. For example, the field device is a control valve or a pump. For example, the control valve can be operated pneumatically, electrically or hydraulically. The field device can be operated with auxiliary energy, such as pneumatic auxiliary energy, wherein in particular a preferably pneumatic drive can be actuated via an in particular electropneumatic position controller. The field device system and in particular the field device can be an unattached field device or a field device integrated in the plant, which is capable of operating the fluids occurring during processing in the process engineering plant under explosion protection. In general, in particular, control valves and pumps are provided to influence, in particular to control and/or regulate, the process fluid flow of the process engineering plant.

The field device system can have, in addition to the at least one field device, at least one, preferably at least two, three or four, particularly preferably at least five, eight or ten, further device(s), in particular selected from attachments, in particular sensors, diagnostic boxes, switches and/or superordinate systems, in particular a safety controller, a control line system and/or a diagnostic system.

A plurality of field devices, in particular control valves, are preferably connected to one another, in particular connected to one another by means of Ethernet APL. The connection can take place directly between the field devices. However, the field devices are preferably connected to one another via at least one switch and/or one diagnostic box. The field devices are preferably connected to at least one switch, which in turn is connected to a diagnostic box. Particularly preferably, all of these connections are implemented via Ethernet APL. Particularly preferably, the field device lines are connected to the switch via track lines. The switch is preferably in turn connected to a diagnostic box and/or a superordinate system via a trunk line.

Particularly preferably, the field device system has a first group of field devices, which are connected to one another via a first switch, in particular APL switch, and at least one second, third, fourth or fifth group of field devices, which in turn are connected to one another via a second, third, fourth or fifth switch, in particular APL switch. In this case, the field devices are preferably connected to the respective switch via track lines. The switches are preferably connected to one another via a trunk line. Furthermore, the switches are preferably connected to a diagnostic box and/or a superordinate system via the trunk line. Particularly preferably, the switches are connected via the trunk line to at least two, in particular three, superordinate systems, in particular selected from a safety controller, a control line system and/or a diagnostic system. Preferably, a power switch is provided between the superordinate systems and the at least one switch or the diagnostic box. The power switch is preferably connected, in particular via Ethernet APL, on the one hand to the superordinate systems and on the other hand to the at least one switch or the diagnostic box.

In addition, the field device system has, in particular, at least one, preferably at least two, three or four, particularly preferably at least five, eight or ten, attachment(s), in particular sensor(s). The at least one attachment is preferably connected via Ethernet, particularly preferably via Ethernet APL, to the field device, a switch, a diagnostic box and/or a superordinate system. Particularly preferably, the attachment is connected directly to the at least one field device, in particular via an Ethernet APL connection, preferably a track line. The at least one field device is preferably in turn connected to a switch via a track line, which switch is in turn preferably connected to a diagnostic box and/or a superordinate system via a trunk line. For example, the at least one attachment can be connected directly to the at least one position controller, in particular a computing unit of the position controller, in particular via Ethernet APL. As a result, in particular cable length can be saved and, at the same time, direct communication between the attachment and the control valve can be provided. However, it is conceivable for the at least one attachment to be connected directly to a switch or a diagnostic box, in particular by means of Ethernet APL.

Furthermore, the field device system can have a process controller controlling at least one device, in particular control valve, attachment, diagnostic box and/or switch. The process controller can be connected to the at least one device by means of a communication network, in particular via Ethernet APL. The connection of the at least one device to the superordinate process controller can also take place via a bus connection, for example via HART, PROFIBUS, FOUNDATION Fieldbus or the like. By linking the process controller to the device, knowledge about the process engineering plant or the field devices thereof can be exchanged and, on the one hand, used globally for the process controller and, on the other hand, fed back into the device for evaluation processes and/or direct control configured by the control unit itself. In this respect, a very flexibly and efficiently operating diagnostic possibility is provided for the process engineering plant.

Furthermore, the field device system can comprise a safety network for safety-related switching on and/or off of field devices, in particular switching on and/or off armatures. The safety network can comprise an actuator of a field device, the sensor and a safety controller, wherein the safety controller can be connected to the field devices via a diagnostic box and/or a switch, in particular by means of Ethernet APL. In an exemplary embodiment, the field devices and/or the sensors are likewise connected to a switch and/or a diagnostic box via an Ethernet APL connection, for example a cable. It is also conceivable that the field devices and/or sensors are connected to the switch and/or the diagnostic box exclusively or additionally via another bus connection, for example via HART, PROFIBUS, FOUNDATION Fieldbus or the like. Alternatively, or additionally, it is possible for the field devices to be connected to one another directly, in particular by means of Ethernet APL. The at least one sensor can be formed as part of a field device or separately. In this case, the sensors and/or the field devices can be supplied electrically with energy fully or partially via Ethernet APL connections. For example, the energy supply can also take place separately via a switch or a diagnostic box. For example, it is possible for only a single connection to run between the plurality of field devices and the safety controller or the superordinate process controller, specifically via the switch or the diagnostic box. In this case, the respective other connection can be formed separately.

In one embodiment, the process engineering system has explosion-prone areas, in particular Zone 2, Zone 1 and/or Zone 0. For example, the process engineering system can have an explosion-prone area of Zone 2. Superordinate systems, in particular a safety controller (safety network), a control line system (process controller) and/or a diagnostic system, of the process engineering system are preferably arranged outside zone 2. Insofar as Zone 1 and Zone 2 are also present in the process engineering system, the superordinate systems are preferably also arranged outside this zone. Alternatively, or additionally, the process engineering system preferably has control devices with explosion protection at least for zone 2, which are arranged in zone 2. The field devices can be connected, in particular, via Ethernet APL, to the superordinate systems arranged outside the zone two. Furthermore, the process engineering system or the control valve system can have at least one switch to which, in particular as described above, a plurality of field devices are connected, in particular, via Ethernet APL. The switch can likewise be arranged in zone 2. Alternatively, or additionally, the process engineering system can have a diagnostic box, which can likewise be arranged in zone 2. In this case, the at least one field device can either be connected directly to the diagnostic box or can be connected to the diagnostic box via the above-described switch. The process engineering system preferably has both the above-described at least one switch and the above-described diagnostic box, which are preferably arranged in each case in zone 2 and are preferably connected to one another via Ethernet APL. Furthermore, the process engineering plant or the field device system can have a power switch to which the at least one field device, and preferably the at least one switch and/or the diagnostic box, are connected, in particular by means of Ethernet APL. The power switch can be connected to a power supply and supply the at least one field device, the at least one switch and/or the diagnostic box with power, in particular by means of Ethernet APL. The power switch can be arranged in zone 2.

Furthermore, the process engineering system can have at least one explosion-prone area of Zone 1. Preferably, at least one field device and/or a switch can have explosion protection for Zone 1. Particularly preferably, a plurality of field devices can be equipped with explosion protection for Zone 1 and can be connected to a switch with explosion protection for Zone 1, in particular by means of Ethernet APL. For example, the plurality of field devices and the switch can be arranged in zone 1 and, in particular via Ethernet APL, can be arranged with a switch, a diagnostic box and/or a power switch, in particular as described above, in zone 2 or outside zone 0, 1 and 2.

Furthermore, the at least one field device can have areas, in particular in the area of the actuator of a field device formed as a control valve, which have explosion protection for Zone 0. These areas of the control valves can then be arranged in an explosion-prone area of Zone 0.

The inventors have recognized that, in particular in connection with the Ethernet APL technology, field devices, in particular control valves, their attachments, switches and diagnostic boxes can be integrated with particularly little cable outlay into explosion-prone areas without having to forego processing units and electrical supply of the field devices, their attachments, switches and diagnostic boxes, such that, in particular, the method according to the disclosure can be carried out particularly efficiently and comprehensively.

The field device system can comprise a communication network, which is configured to connect the at least one sensor to a diagnostic box for receiving and processing the image and/or sound data from the sensor for signal transmission by means of Ethernet APL.

A diagnostic box within the meaning of the present disclosure is, in particular, a device having at least one computing unit. The diagnostic box is designed in particular to receive data, in particular measured values, from the at least one field device and/or a superordinate system and/or to send them to the field device and/or a superordinate system. For example, the diagnostic box can be designed to receive data, in particular measured values, from the at least one field device. In particular, the diagnostic box can be designed to filter and/or pre-evaluate received data and to forward the filtered and/or pre-evaluated data to a superordinate system. The filtering can comprise in particular the comparison of received data, in particular measured values, with stored tolerance ranges and/or a selective forwarding of specific data. For example, it can be provided that a sensor is designed for continuously measuring the position of a valve member of a field device configured as a control valve, but the diagnostic box forwards only changes in the position of the valve member to the superordinate system. Alternatively, or additionally, the diagnostic box can be formed to carry out an evaluation for error causes in the event of deviations from a tolerance range and, when a possible error is identified, either to carry out an error correction on the field device directly, for example by updating software packages, or to communicate the error to a superordinate system.

Alternatively, or additionally, the diagnostic box can also be designed to receive announcements of updates, in particular, centrally, from a superordinate system and to forward them to the at least one field device, attachment and/or switch. Preferably, however, the categorization of the updates takes place centrally via the diagnostic box. For this purpose, the diagnostic box can be designed to check the presence of defined conditions on the basis of information on the updates supplied with the announced updates and/or to query the at least one field device, attachment and/or switch by querying data, in particular measurement data. Alternatively, or additionally, the diagnostic box can be designed to store data received from the at least one field device, attachment and/or switch, in particular data which could be relevant for a categorization of possible future updates, and to use them for the categorization in the case of the announced update. Furthermore, the diagnostic box can be designed to define the time of the update and/or bridging functions to be carried out during the update as a function of the categorization. For this purpose, the diagnostic box can be designed in particular to give corresponding instructions to the at least one field device and/or switch. The functionalities explained above in connection with the diagnostic box can alternatively or additionally also be provided on a switch, an attachment, a field device or a superordinate system of the process engineering plant.

In one embodiment, the field device system has a control valve for controlling a process fluid flow of a process engineering plant, such as a chemical plant, a power plant, a food processing plant or the like, wherein the control valve has a first computing unit for controlling the control valve and a second computing unit, which is designed to assume at least one function of the first computing unit in the event of a failure and/or updating of the first computing unit.

The control valve can be operated with auxiliary energy, such as pneumatic auxiliary energy. In particular, the control valve can have a position controller, in particular a pneumatically and/or electropneumatically operated position controller. Furthermore, the control valve can have a valve member which can be adjusted via the position controller, in particular in order to open and/or close or partially close a fluid passage opening. Furthermore, the control valve can have a drive, in particular an electrical or pneumatic drive, in order to adjust the valve member. The drive can be connected to the valve member via a control rod. Furthermore, the control valve can have an enclosure. The enclosure can have a valve member housing, a valve rod housing and/or a drive housing. Preferably, the control valve has a position controller. The position controller is preferably fastened to the enclosure, in particular fastened to the valve rod housing. In particular, the position controller is arranged, in particular, fastened, in the area of the valve rod. Embodiments are also possible in which the position controller is fastened via the drive or a structure of the drive.

According to this embodiment, the first and the second computing unit are part of the control valve. The first and second computing units can be arranged, for example fastened, on different areas of the control valve. For example, one computing unit can be arranged in the position controller and another computing unit can be arranged in the drive. However, the first and second computing units can also be arranged adjacent to one another (in particular in a common component of the control valve). For example, the first and the second computing units can be arranged in the position controller.

Preferably, the computing unit is a computing unit of the position controller. Particularly preferably, the first computing unit is designed to control, in particular to regulate, the position of the valve member. In a preferred embodiment, the second computing unit is preferably likewise part of the position controller. In this case, the second computing unit is preferably designed to completely assume at least the function for controlling, in particular regulating, the valve member, in the event of a failure and/or updating of the first computing unit. Preferably, the second computing unit is designed to at least partially, preferably completely, assume all the functions of the computing unit in the event of its failure and/or updating of the first computing unit.

The inventors have recognized that, by integrating the first and second computing units into the control valve, downtimes of the control valve, in particular as a result of a failure of the first computing unit and/or an updating of the first computing unit, can be significantly reduced. In this case, in particular by integrating both computing units into the control valve, the cabling complexity can be significantly reduced in relation to solutions in which the second computing unit and/or the first computing unit is arranged outside the control valve. At the same time, the adoption of the at least one function can take place more reliably because direct communication of the two computing units with one another is enabled. In contrast thereto, for example in embodiments in which at least one of the two computing units is connected to one another via a switch outside the control valve, an overload or a failure of the switch can lead to the second computing unit not being able to assume the function of the first computing unit. Even in the event of overloading of the data transmission between the two computing units via a switch, the adoption of the function by the second computing unit (bridging function) can be disturbed, in particular prevented. Furthermore, by integrating the first and second computing units into the control valve, the number of connections for connecting the control valve to a switch, a superordinate system or a diagnostic box can be reduced. By reducing the connections, the risk of sparking or critical currents in the region of the connections can also be reduced and the risk of explosion can thus be reduced.

Preferably, the first and the second computing units are mounted in an explosion-protected area of the control valve, for example, the first and the second computing units can be arranged in an enclosure of the control valve, for example in an enclosure of the position controller, which are explosion-protected. In particular, the enclosure can have explosion protection for Zone 2, preferably Zone 1, particularly preferably Zone 0. Furthermore, at least one explosion-protected connection is preferably provided on the enclosure, via which the control valve can be connected to another device, in particular control valve, switch, diagnostic box and/or superordinate system, preferably via an Ethernet APL cable.

The first computing unit and/or the second computing unit can be designed to monitor the functionality and/or upcoming updates of the first computing unit (preferably of the respective other computing unit). Alternatively, or additionally, the functionality and/or upcoming update of the first computing unit can be monitored by a further control valve, an attachment, a diagnostic box, a switch or a superordinate system. When a failure or an upcoming update of the first computing unit is established, the monitoring of the device can be designed to initiate an adoption of the function by the second computing unit. Preferably, the first computing unit, the second computing unit and/or one of the further devices described above can be formed to carry out one or more of steps a), b) and c) of the method according to the disclosure.

In a further embodiment, which can be combined with the preceding embodiment and vice versa, the control valve system has an attachment for a control valve for controlling a process fluid flow of a process engineering plant, such as a chemical plant, a power plant, a food processing plant or the like. The attachment has a second computing unit, which is designed to assume at least one function of the first computing unit in the event of a failure and/or updating of a first computing unit of the control valve.

The attachment can be designed to be fastened to a control valve. In particular, the attachment can have a connection for mounting on a control valve. Particularly preferably, the attachment is designed to be fastened to an enclosure, in particular a control rod housing, of the control valve. The second computing unit can be arranged in the enclosure of the attachment. The enclosure of the attachment can be designed to be explosion-protected, in particular with regard to explosion-prone areas of Zone 2, preferably Zone 1, particularly preferably Zone 0. The enclosure can seal the second computing unit, in particular, hermetically, with respect to the surroundings. The enclosure can be designed to communicate with the control valve. The communication with the control valve can take place wirelessly or by means of cable. In addition, the communication with the control valve can take place directly, for example by a direct connection to the control valve, for example by a connection via a further device, such as a switch, a superordinate unit and/or a diagnostic box. Preferably, the attachment is connected directly to the control valve, particularly preferably directly to a position controller of the control valve. The connection between attachment and control valve preferably takes place via Ethernet, particularly preferably Ethernet APL.

The attachment can have further devices, such as a further computing unit and/or a sensor. Preferably, the attachment has a sensor. The sensor can be formed to measure process variables, in particular temperature, volume flow and/or pressure, of the process fluid flow. Alternatively or additionally, the attachment can have a further computing unit for operating the sensor. In this case, it can be provided that, in addition to the adoption of the functions of the first computing unit, the second computing unit can be designed to control the further device, such as the sensor, of the attachment.

The inventors have recognized that the attachment can constitute an alternative to the embodiment having a first and second computing unit in the control valve. A particular advantage of this embodiment is that the attachment can be retrofitted to existing control valves and process engineering plants. The downtime of software packages of the control valve, in particular as a result of failure and/or updating, can therefore also be reduced in the case of existing, and in particular, older plants. In this case, in particular by mounting the attachment in the area of the valve rod, in particular, on the valve rod housing, the cabling complexity, in particular for the connection between attachment and computing unit, can be significantly reduced.

A further embodiment of the control valve system, which can be designed like the two embodiments described above and vice versa, comprises a control valve with a first computing unit for controlling the control valve and a second computing unit, which is designed to assume at least one function of the first computing unit in the event of a failure and/or updating of the first computing unit. In this embodiment, the first computing unit is part of the control valve. The positioning, fastening and/or connection of the first computing unit to further devices, in particular the second computing unit, a further control valve, an attachment, a switch, a diagnostic box and/or a superordinate system, can be implemented as in connection with the two embodiments described above. The second computing unit can part of the control valve. However, it can be designed independently of the control valve. In particular, the second computing unit can be designed in an attachment, in particular for a control valve. However, the second computing unit can also be configured in other devices, for example in a further control valve, a switch, a diagnostic box or a superordinate system.

For example, the control valve system can have at least one further control valve, wherein the second computing unit is part of the further control valve. In such an embodiment, the second computing unit can be a computing unit which is designed to control the second control valve. Particularly preferably, the first computing unit is designed to assume at least one function of the second computing unit in the event of a failure and/or updating of the second computing unit. In this embodiment, the first and the second computing unit each provide bridging functions mutually for one another. Downtimes can thereby be reduced without having to provide additional computing units. Preferably, the first and second control valves are connected to one another for this purpose, in particular, connected to one another via Ethernet, particularly preferably via Ethernet APL. The connection can take place directly or indirectly. An indirect connection can take place, for example, via the fact that further control valves, in particular their computing units, are connected to a common switch. Preferably, the control valve system furthermore has a diagnostic box which is connected to the second control valve via Ethernet, in particular via Ethernet APL. The connection can be direct or indirect. An indirect connection can be implemented, for example, by the fact that the diagnostic box is connected to the two control valves via a common switch. Furthermore, the diagnostic box and/or the two control valves can be connected to at least one superordinate system, preferably at least two or three, in particular as described above. The connection can take place directly or indirectly. Preferably, the connection to the superordinate system takes place via a common switch (indirectly). Particularly preferably, the control valve system has a power switch which supplies the above-described switch with energy. It can be provided that the diagnostic box is arranged between the switch and the power switch and is connected, in particular directly, in each case via Ethernet, preferably via Ethernet APL, to the switch and the power switch. The superordinate system can be connected to the further components via the power switch.

Alternatively, the second computing unit can be arranged in a diagnostic box of the control valve. The diagnostic box can be connected directly or indirectly to the control valve. The diagnostic box is preferably connected indirectly, in particular via a switch, to the control valve. Particularly preferably, the connection between the diagnostic box, the switch and the control valve takes place via Ethernet, in particular Ethernet APL. In addition, the system preferably has a power switch which supplies the switch with power, in particular via Ethernet APL. The diagnostic box is preferably arranged between the switch and the power switch and is preferably connected in each case via Ethernet APL to the switch and the power switch. The control valve system can have further control valves which are connected to the switch and the diagnostic box and/or the first control valve.

Alternatively, the second computing unit can be part of a superordinate system of the control valve system, for example a safety controller, a control line system and/or a diagnostic system. The superordinate system can be connected to the control valve, preferably via Ethernet APL. Preferably, the control valve system in this embodiment likewise has a diagnostic box and/or a switch, via which the superordinate system is connected to the control valve, and preferably further control valves.

The field device system described above can be formed to carry out the method according to the disclosure. The method according to the disclosure can be executed with the field device system according to the disclosure, in particular can be executed in such a way that it can be executed with such a field device system. The embodiments and/or embodiments described in connection with the respective aspects of the disclosure can be formed and/or carried out individually or jointly in the different aspects of the disclosure.

The disclosure furthermore relates to an instruction set comprising commands which, when the instruction set is executed by a field device, in particular a control valve and/or an attachment for a field device, in particular control valve, a field device system, in particular control valve system, or a process engineering system, cause the latter to carry out the method described above.

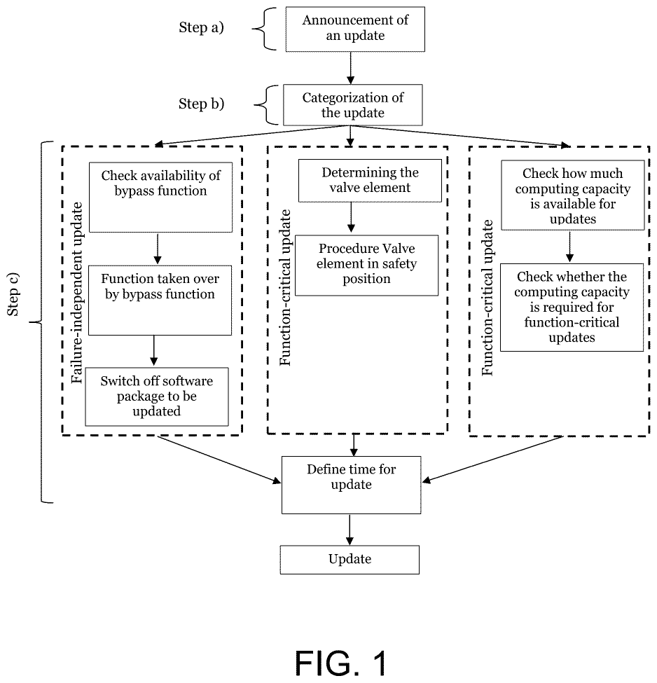

FIG. 1 shows a schematic flow diagram of a method according to the disclosure. The steps a) (announcement of an upcoming update of at least one of the software packages) and b) (categorization of the update as a function of defined conditions) are indicated schematically therein. For step c) (definition of the time of the update and/or of bridging functions to be carried out during the update as a function of the categorization), three exemplary sequences which can be established in the method according to the disclosure as a function of the categorization in step b) are outlined via the dashed boxes. The three sequences can take place simultaneously or successively. It is clear that the sequences shown are merely exemplary in character. Thus, more or fewer sequences can also take place simultaneously or successively. Moreover, the sequences can comprise further, different and/or fewer steps.

The left-hand box shows an exemplary sequence of step c) for an updating which was categorized as non-failure-critical in step b). For example, this can be the updating of a software package for controlling the position of a valve member of a field device configured as a control valve. Such an updating can be classified as non-failure-critical in step b) if the function of the software package to be updated is defined as being able to be compensated. For example, a position controller of the control valve can have two identical software packages which are suitable independently of one another for controlling the control valve position. In such cases, in step b), the updating can be categorized as non-failure-critical to the effect that the second software package can provide a bridging function with which the function affected by the updating can be adopted completely. In step c), it can be checked in a first substep whether the bridging function is available. If the bridging function is not available, for example because the software package responsible for this is currently updated itself or assumes the function of another position controller, a second check can be initiated at a later time. If the bridging function is available, the adoption of the function from the software package to be updated can take place in a second substep by the redundant software package. As soon as the function has been adopted, the function of the software package to be updated can be switched off in a third substep and subsequently a time for the updating can be defined. Finally, the updating can take place. After the update, the updated software package can assume the function again.

The middle box shows an exemplary sequence of step c) for an updating which was categorized as function-critical in step b). For example, this can be the updating of a software package for controlling the position of a valve member of a field device configured as a control valve. Updates relating to corresponding software packages are preferably categorized as function-critical. If no bridging function is available for such software packages, they can be categorized as function-critical and failure-critical. In such cases, it can be provided to determine the position of the valve member in a first substep of step c). If the valve member is not in a safety position, the valve member can be moved into the safety position in a second substep and then the time for the updating (for example immediately after adopting the safety position) can be defined in a third substep. The updating can subsequently take place.

The right-hand box shows an exemplary sequence of step c) for an updating which was categorized as function-critical in step b). For example, updates which relate to software packages with functions for a user interface can be categorized as non-function-critical in step b). Such functions can in principle be updated at any desired time without having to provide a bridging function or having to switch off the process engineering plant or directly affected field devices or having to put them into a safety position. Since the failure of an update categorized as non-function-critical generally does not result in a failure of the entire plant or part of the plant, such categorizations also do not necessarily have to take place immediately. In this respect, in the case of such updates, it can be provided that, in a first substep, it is checked whether or how much computing capacity is available for updates. In a second step, it can then be checked whether the computing capacity which is available in principle is required for updates which are function-critical or are to be prioritized. If this is the case, the updating categorized as non-function-critical can be delayed until sufficient computing capacity is available which is not otherwise required. If the computing capacity is not otherwise required, the time for the updating can be defined immediately in a further substep. Finally, the updating can then take place.

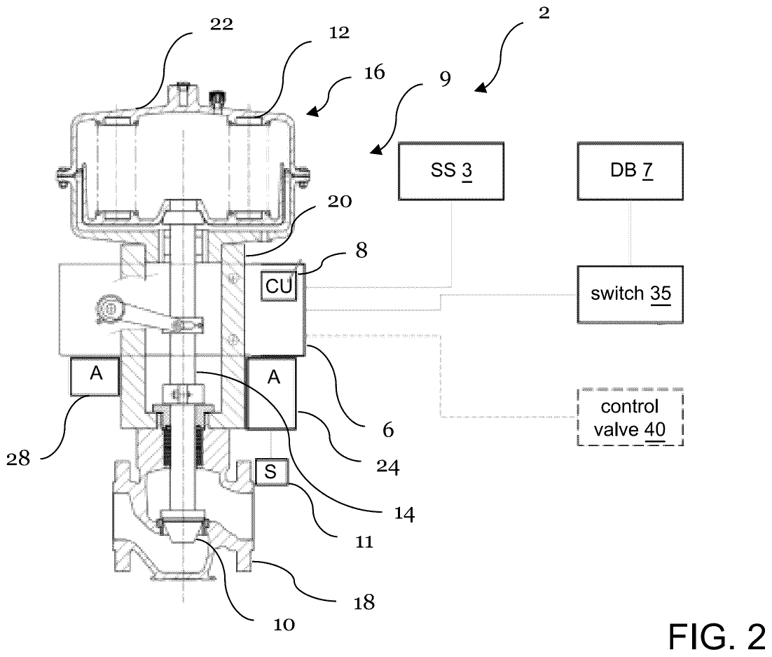

FIG. 2 shows an exemplary embodiment of a field device system 2 according to the disclosure in the form of a control valve system 2. The control valve system 2 has a field device designed as a control valve 9. The control valve 9 has a position controller 6 with a computing unit 8, on which an individually executable software package for controlling the valve member position is installed. The computing unit 8 is designed, during the announcement of an upcoming update of a software package, to categorize the update as a function of defined conditions and, as a function of the categorization, to carry out a time of the update and/or bridging functions to be carried out during the update, in particular to carry them out according to the method according to the disclosure. Alternatively or additionally, however, other computing units of the control valve system, for example in one or more of the attachments 24, 28 described below, the switch 35 described below, the diagnostic box 7 described below, the superordinate system 3 described below or the further field device 36 described below, can also be correspondingly designed.

Furthermore, the control valve 9 has a valve member 10, a drive 12 for controlling the valve member and a valve rod 14, which connects the valve member 10 to the valve drive 12. Furthermore, the control valve has an enclosure 16 which has a valve member housing 18, a valve rod housing 20 and a drive housing 22.

Furthermore, the control valve system 1 has an attachment 24 for a redundant computing unit (not represented), which is designed to provide a bridging function for the software package installed on the computing unit 8 of the position controller 6. In the present case, the attachment is attached to the valve rod housing 20. However, it can also be arranged on other areas of the control valve 9, for example on the drive housing 22 or on the valve member housing 28, or at a distance from the control valve 9. The computing unit in the attachment 24 can be designed to carry out a bridging function, for example when updating a software package from one of the other computing units, for example the attachment 28 and/or the position controller 6. The computing unit of the attachment 24 can be connected directly to the computing unit 8 or another device, for example the switch 35 illustrated in FIG. 2, in particular can be connected via Ethernet APL.

Furthermore, the control valve system 1 has a sensor 11 for measuring process variables, in particular volume flow, temperature and/or pressure, of a fluid, in particular fluid flow, in the valve member housing 18. Furthermore, in the present case, the control valve system 2 has a further attachment 28 having a computing unit (not represented) for the sensor 11. The computing unit can be formed to read out, process and/or forward the process variables measured by the sensor. Alternatively or additionally, the computing unit in the attachment 28 can be designed to carry out a bridging function, for example when updating a software package from one of the other computing units, for example the attachment 24 and/or the position controller 6. The computing unit of the attachment 28 can be connected directly to the computing unit 8 or another device, for example the switch 35 illustrated in FIG. 2, in particular can be connected via Ethernet APL.

Furthermore, the control valve system 2 has a switch 35 via which the control valve 9 is connected to a diagnostic box 7 of the control valve system 2, in particular by means of Ethernet APL. Computing units of the attachments 24 and 28 can be connected to the switch 35 via the position controller 6 or can be connected directly to the switch 35. The diagnostic box 7 can be designed to announce updates of software packages via the switch 29 to the corresponding computing units, for example of the position controller 6 and/or one or more of the attachments 24 and 28. Alternatively or additionally, the diagnostic box 7 can be designed to receive, evaluate, filter and/or forward data, for example measurement data from the sensor 11 or the control valve position from the position controller 6, for example to a further superordinate system, not illustrated.

Furthermore, in the present case, the control valve system 2 has a superordinate system 3 connected directly to the position controller 6. This can be used, for example, to communicate updates directly to the position controller, in particular while bridging the diagnostic box 7. However, it can also be provided that the superordinate system 3 and/or further superordinate systems is/are connected to the position controller 6 via the diagnostic box 7 and/or the switch 35.

In the present case, the control valve system 2 furthermore has a further, schematically represented control valve 40. In the present case, the further control valve 40 is connected directly to the position controller 6 of the control valve 9. As a result, the control valves 9 and 40 can execute bridging functions mutually for one another when software packages of the one control valve are updated. In addition, as a result, coordination of the control valves 9 and 40 with one another can take place during the definition of the time for an update. However, it is also conceivable for the further control valve 40 and possibly further control valves (not represented) to be connected to one another via the switch 35 or a power switch (not represented).

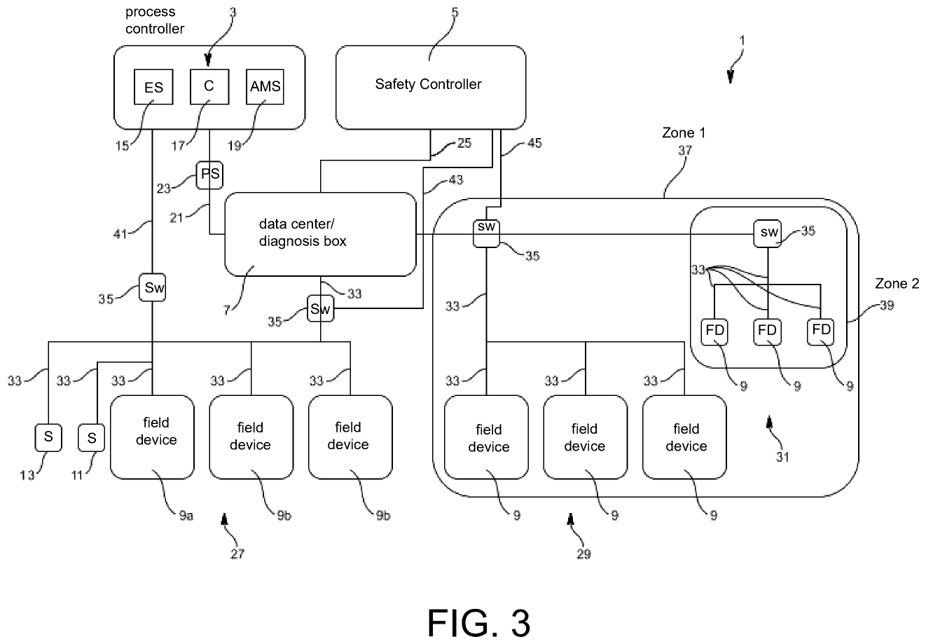

FIG. 3 shows an exemplary process engineering plant 1. The process engineering plant 1 can be, for example, a chemical plant, a power plant, a food processing plant or the like.

The process engineering system 1 comprises a process controller 3, a safety controller 5, a diagnostic box 7 and a plurality of field devices 9. A process fluid flow of the process engineering plant 1 can be set by means of the field devices 9. The field devices 9 can be control valves, for example. The process engineering system 1 also has a plurality of sensors for capturing measurement data. The sensors can either be assigned directly to a field device 9, such as the sensor 11 in FIG. 3, or can capture data independent of the individual field devices 9, such as the sensor 13 in FIG. 3.

The process controller 3 serves to control the process engineering system 1 and has, for example, an engineering system 15, a controller 17 and an asset management system 19. The process controller 3 is connected to the diagnostic box 7 via a line 21. In this case, the line 21 can be used at the same time to provide power or current and for data transmission. In other words, a simultaneous transmission of a plurality of signals is possible via the line 21. In particular, the line 21 is an Ethernet APL line. An APL power switch 23, which serves to provide power, is interposed between the process controller 3 and the diagnostic box 7.

The safety controller 5 is part of a safety circuit, which comprises the safety controller 5 and all devices of the process engineering system 1. The safety controller 5 is capable of controlling the devices independently of the process controller 3. The safety controller 5 is likewise connected to the diagnostic box 7 via a line 25, which can likewise be an Ethernet APL line. The process controller 3 and the safety controller 5 form superordinate systems for open-loop and/or closed-loop control of the process engineering system 1. The diagnostic box 7 can additionally be connected to a cloud (not illustrated in FIG. 3), which can then likewise be a superordinate system of the process engineering plant 1 and/or via which access to the captured data and/or the system controller 3 can be possible.

In the embodiment in FIG. 3, the field devices 9 are arranged in three clusters 27, 29, 31, which each have a plurality of field devices 9. Data transmission is possible in each case between the field devices 9 of a cluster 27, 29, 31, in other words, the field devices 9 of a cluster are connected to one another via a communication network. Furthermore, in the embodiment in FIG. 3, data transmission between the clusters 27, 29, 31 and the diagnostic box 7 is possible. For this purpose, the field devices 9 are connected to one another and to the diagnostic box 7 by way of track data lines 33, which are preferably Ethernet APL lines. In order to connect the lines 33 of the individual field devices 9 collectively to the diagnostic box 7, an APL switch 35 for merging the lines 33 is arranged in each case between a cluster 27, 29, 31 and the diagnostic box 7.

The lines 33 also enable electrical shielding, with the result that no ignitable energy is achieved, but rather the energy reliably remains below an ignitable level. As a result, the field devices 9 and the APL switches 35 can also be used in explosion-prone areas of Zone 1 and 2. In FIG. 3, the field device cluster 29 is arranged in Zone 1, which is indicated by the reference symbol 37, and the field device cluster 31 is arranged in Zone 2, which is indicated by the reference symbol 39.

A connection between the field device clusters 27, 29, 31 and the process controller 3 and/or a connection between the field device clusters 27, 29, 31 and the safety controller 5 is also possible in each case via an additional parallel line. In FIG. 1, by way of example, the field device cluster 27 is connected directly to the process controller 3 via a line 41 and an APL switch 35, such that the process controller 3 is also connected directly to the field device cluster 27 in parallel with the connection via the diagnostic box 7. In a similar manner, the field device cluster 27 in FIG. 1 is also connected directly to the safety controller 5 via an additional line 43, wherein, however, no additional APL switch is provided, but rather the line 43 connects the safety controller 5 to the APL switch 35, which is provided between the field device cluster 27 and the diagnostic box 7. It is clear that, alternatively, the line 43 can also have an additional APL switch and that, alternatively, the line 41 can also be connected to the APL switch 35 between the field device cluster 27 and the diagnostic box 7. It is also clear that additional lines can also be provided for the further field device clusters 29, 31, which additional lines connect the respective field device cluster 29, 31 directly to the process controller 3 and/or the safety controller 5, which is indicated by way of example by the line 45 between the safety controller 5 and the further field device clusters 29, 31.

The features disclosed in the preceding description, the figures and the claims can be significant both individually and in any combination for the implementation of the disclosure in the various embodiments.

### REFERENCE SIGNS

1 Process Engineering Plant
2 Control Valve System
3 Process controller
5 Safety controller
6 Position Controllers
7 Diagnostic Box
8 Computing unit
9 Control valve
10 Valve member
11 Sensor
12 Drive
13 Sensor
14 Valve rod
15 Engineering System
16 enclosure
17 Control
18 Valve member housing
19 Management System
20 Valve rod housing
21 Line
22 Drive housing
23 APL Power Switch
24 Attachment
25 Line
27 cluster
28 Valve member housing
29 cluster
31 cluster
33 Line
35 APL switch
36 Field device
37 Zone 1
39 Zone 2
40 Control valve
41, 43, 45 Line

1. A method for reducing downtimes in updating of individually executable software packages for controlling and/or monitoring a field device of a process engineering system, the method comprising:
a) announcing an upcoming update of at least one of the software packages;
b) categorizing, based on the defined conditions, the upcoming update; and
c) defining, based on the categorization, a time of the update and/or of bridging functions to be carried out during the update.

2. The method according to claim 1, wherein, in step b), updates of software packages whose function is defined as a primary function of the field device and/or of the process engineering system are categorized as function-critical updates.

3. The method according to claim 2, wherein:
functions for controlling the control valve position, for providing safety functions, and/or for communicating the field device with a safety controller and/or a process control system, are defined as a primary function; and/or
functions relating to a user interface and/or diagnostic functions are not defined as a primary function.

4. The method according to claim 2, wherein, in step c), for updates categorized as non-function-critical, a time for the updating is defined at which computing capacities required for the updating are not required for updates categorized as function-critical.

5. The method according to claim 1, wherein, in step b), updates of software packages whose function is defined as being compensatable during the update are categorized as non-failure-critical updates.

6. The method according to claim 5, wherein functions which are at least partially defined as being compensatable at least partially adopted during an update.

7. The method according to claim 5, wherein, in step c), for updates categorized as non-failure-critical, initiating, before carrying out the updating, bridging functions for compensating the function affected by the updating.

8. The method according to claim 7, wherein the bridging functions comprise:
a complete adoption of a concerned function during the update, which is stored on a second computing unit of another field device of the process engineering system or a diagnostic box,
a partial compensation by an autonomous control routine during the update, which is stored on a second computing unit of another field device of the process engineering system or a diagnostic box, and/or
a partial compensation by a rudimentary basic function during the update in the updating of a software package for controlling the control valve position of the control valve, a setpoint value for holding the control valve position is held.

9. The method according to claim 7, wherein, after the updating, the function is adopted again by the updated software package.

10. The method according to claim 5, wherein, in step c), for updates categorized as non-failure-critical, defining a time for the updating at which computing capacity required for the updating is not required for updates categorized as failure-critical.

11. The method according to one of claim 2, wherein, in step c), for updates categorized as non-function-critical and as failure-critical, defining a time for the updating at which computing capacities required for the updating are not required for updates categorized as function-critical and as non-failure-critical.

12. The method according to claim 2, wherein, in step c), for updates categorized as function-critical and as non-failure-critical, defining a time for the updating at which sufficient computing capacity is available for the updating and for the bridging function.

13. The method according to claim 1, wherein, in step c), a time of the updating is defined as a function of an instantaneously or future planned operation of the control valve and/or of the process engineering plant.

14. The method according to claim 13, wherein a time is defined as a function of a control signal of the process control system, a state of the computing unit, and/or a state of the safety controller.

15. The method according to claim 13, wherein, in step c), a time of the updating is defined in a time window in which no changes in the control valve position are planned.

16. The method according to claim 1, wherein, in step b), updates which are announced as a consequence of a cause defined as urgent are categorized as time-critical updates.

17. The method according to claim 14, wherein a failure or disruption of a function defined as a primary function and/or safety gaps with respect to access from outside to the control valve, to other field devices of the process engineering plant, or to the entire process engineering plant, are defined as an urgent cause.

18. The method according to claim 16, wherein, in step c), for updates categorized as non-time-critical, defining a time for the updating at which computing capacity required for the updating is not required for updates categorized as time-critical.

19. The method according to claim 1, wherein, for updates categorized as both function-critical and/or time-critical and as failure-critical, in step c), a decision is made by an algorithm based on weighting factors as to whether a downtime of the field device and/or of the process engineering plant is accepted in favor of a timely update, or whether the update is shifted to a time at which the update can be carried out during a planned downtime.

20. The method according to claim 1, wherein, in step c), the field device is brought into a safety position before carrying out an updating categorized as failure-critical and/or as function-critical.

21. The method according to claim 1, wherein updates are blocked in step c) in response to the updates leading to an excessively high utilization of computing capacities.

22. The method according to claim 1, wherein the software packages are distributed over a plurality of computing units and/or devices of the process engineering system, which are connected to one another via Ethernet, and/or a switch.

23. The method according to claim 1, wherein, for the definition of the time of the update, step c), a coordination between devices of the process engineering plant takes place as a function of an upcoming maintenance or update on a second device, and/or wherein software packages of a plurality of devices take place simultaneously for all devices.

24. The method according to claim 1, wherein, during the carrying out of a bridging function, by a control routine, in step c), the control routine is communicated to other devices, and/or the other devices take the control routine into account in their behaviour.

25. A field device system for controlling a process fluid flow of a process engineering plant, the system comprising:
a memory storing at least one individually executable software package for controlling and/or monitoring a field device; and
at least one computer configured, during an announcement of an upcoming update of a software package, to categorize the update as a function of defined conditions and, as a function of the categorization, to carry out a time of the update and/or bridging functions to be carried out during the update.

26. (canceled)
